(19) United States
(12) Patent Application Publication
(10) Pub. No.: US 2024/0393559 A1
(43) Pub. Date: Nov. 28, 2024

(54) EXTREMELY HIGH DENSITY CABLE ROUTING ASSEMBLIES FOR DATA COMMUNICATION

(71) Applicant: Amphenol Network Solutions, Inc., Liberty Lake, WA (US)

(72) Inventor: Bryan Kioski, Liberty Lake, WA (US)

(73) Assignee: Amphenol Network Solutions, Inc., Liberty Lake, WA (US)

(21) Appl. No.: 18/674,163

(22) Filed: May 24, 2024

Related U.S. Application Data
(60) Provisional application No. 63/504,277, filed on May 25, 2023.

(51) Int. Cl. G02B 6/44

(52) U.S. Cl. CPC G02B 6/4471

(57) ABSTRACT

A chassis that supports an extremely high density of fiber optic connections. The chassis may be populated with multiple rows of modules, each supporting multiple single fiber connections made with components implemented according to the LC standard. The chassis may fit within a 1 rack unit space, providing 168 LC connections per rack unit. This density may be achieved with structures that occupy little or no space within the rack unit footprint. Some of the rows of modules may be tray-less. Cable management components may be mounted to impede access to portions of a module but may flex to allow access. Modules may slide on rails that extend into the module from the rear, but do not extend to the front of the module. Sides of the chassis enclosure and a tray in the enclosure may be configured for enabling motion of the tray relative to the chassis enclosure.

### CROSS-REFERENCE TO RELATED APPLICATIONS

This application claims priority to and the benefit under 35 U.S.C. § 119 (e) of U.S. Provisional Patent Application Ser. No. 63/504,277, filed on May 25, 2023, entitled “EXTREMELY HIGH DENSITY CABLE ROUTING ASSEMBLIES FOR DATA COMMUNICATION SYSTEMS,” which is hereby incorporated herein by reference in its entirety.

### TECHNICAL FIELD

The apparatus and techniques described herein relate generally to high data rate networks and more specifically to management of optical fibers.

### BACKGROUND

### Discussion of the Related Art

In modern networks, high data rate connections may be made with fiber optic cables having one or more optical fibers. A server or a network switch, for example, may be connected to multiple other network devices through the optical fibers of one or more fiber optic cables.

Often, the network devices connected via fiber optic cables are mounted in equipment racks, cabinets or frames. Each equipment rack, cabinet or frame may have mounting features for securing components such as servers, chassis, power components, routing features or other data communication components. The mounting features may be positioned on the rack, cabinet or frame to accommodate connection thereto by components having a standardized height and width. An example of a standard height is a rack unit, abbreviated as U or RU (for example, 1U or 1RU). For example, a network component such as a server, power unit, or switch may have a height equal to an integer number of rack units, such as 1U, 2U, 3U or 4U. In some cases, the width of the network component is also a standard size, such as 19 inches or 23 inches.

A network facility, such as a server farm, may have rows of racks, cabinets, frames or a combination of the foregoing, each populated with multiple components. The number of racks, cabinets and frames, and the number of components secured thereto, in a network facility creates challenges for managing the connections between components and for accommodating the desired number of fiber connections. For example, each component might be connected to multiple other components via fiber optic cables, creating a need to organize and route many fiber optic cables within and between racks in the network facility. In another example, a network facility may require a certain number of fiber optic connections within a certain area of the facility, within a rack, cabinet or frame, or with a certain space (e.g., 1RU) within a rack, cabinet or frame.

To help manage these connections, the components, which are couplable to a cabinet, rack or frame, may include a chassis that accepts and holds one or more modules having optical fiber adapters for coupling with the connectors of the fiber optic cables. Each chassis may hold multiple modules, each of which may have multiple adapters to receive optical fiber connectors of the fiber optic cables. For example, the modules may include adapters to receive single fiber connectors, such as LC connectors, or multifiber connectors such as a multifiber push-on connector (MPO).

While individual optical fibers are very thin such that many optical fibers fit in a small space, the space required for optical connections can be much larger. It can be difficult to fit the desired number of optical connections into a rack, cabinet or frame, or into a certain amount of space within a rack, cabinet or frame (such as a 1U space) and to make those optical connections accessible to a technician so that, for example, connectors can be easily connected and disconnected without damaging the equipment or disrupting the connection of other connectors in the rack, cabinet or frame. In other words, it can be difficult to accommodate the desired number of optical connections and leave sufficient clearance for a technician to access the connections. Moreover, space is required within a rack, cabinet or frame for components that perform other functions, such as mounting features to couple components to the rack and routing features for routing fiber optic cables to and from components or the rack, cabinet or frame.

Indeed, some manufacturers of optical fiber routing equipment have taken the position that the maximum density of connections that could be made through a optical fiber routing equipment with LC connectors (whether simplex or duplex) is about 144 per 1U.

### BRIEF SUMMARY

Some aspects of the technology provide a module for a fiber distribution chassis having a connection density of 168 LC connections per rack unit.

Some aspects of the technology provide a module for a high density fiber distribution chassis, comprising: a housing comprising a front face; a plurality of optical fiber connection elements exposed in the front face; and an element. The element comprises a first portion affixed to the housing adjacent at least a subset of the optical fiber connection elements of the plurality of optical fiber connection elements; a flexure coupled to the first portion; and a distal portion, coupled to the flexure, having a maximum width wider than the flexure. The flexure is configured to flex in a direction to move the distal portion alternatively towards the at least a subset of the plurality of optical fiber connection elements or away from the at least a subset of the plurality of optical fiber connection elements.

Some aspects of the technology provide a high density fiber distribution chassis having a front, comprising: a plurality of modules, each module comprising fiber optic connection elements exposed at the front. The plurality of modules are disposed in a plurality of rows. At least one of the plurality of rows is trayless such that the plurality of modules provide within the chassis a density of fiber optic connections of at least 148 LC connections per rack.

### BRIEF DESCRIPTION OF DRAWINGS

In the drawings, each identical or nearly identical component that is illustrated in various figures is represented by a like reference character. For purposes of clarity, not every component may be labeled in every drawing.

FIG. 1 is a front perspective view of a chassis of a fiber distribution frame in a rack, with a front cover open;

FIG. 2 is a front plan view of the fiber distribution frame of FIG. 1, without the front cover;

FIG. 3 is a front perspective view of the chassis of FIG. 1, without the front cover and a right side rail and with a chassis cover shown partially exploded to expose a side of a tray within the chassis;

FIG. 4 is a front perspective view of the chassis of FIG. 3 without the chassis cover, a tray top, right side cable management components and right side tray detent mechanism, and a module slid forward into a service position;

FIG. 5A is a front perspective view of the chassis of FIG. 4 with four stacks of modules removed;

FIG. 5B is a perspective view of the rail subassembly of FIG. 5A;

FIG. 6 is a front perspective view of the chassis of FIG. 5A with a top of a module removed;

FIG. 7A is a front perspective view of a module of the chassis of FIG. 1;

FIG. 7B is a rear perspective view of the module of FIG. 7A;

FIG. 8 is a front perspective view of the bottom portion of the module housing of FIG. 7A;

FIG. 9 is an enlarged view of a portion of the chassis of FIG. 4, showing a positioning magnet;

FIG. 10 is a rear perspective view of the chassis of FIG. 1 with a rear cover open.

FIG. 11 is a perspective view of conventional LC connectors in both a simplex configuration and a duplex configuration, both mated to adapters and unmated.

### DETAILED DESCRIPTION

The inventors have recognized and appreciated designs for optical fiber distribution equipment that supports a connection density of greater than 144 connections made with simplex or duplex LC connectors per 1U. In some examples, optical fiber distribution equipment may support a connection density of greater than 146 connections per 1U, such as a maximum number of LC connections in the range from 146 to about 168 connections per 1U or about 168 LC connections per 1U. Such connection densities may be achieved using one or more design techniques as described herein.

Further, such connection densities may be achieved in optical fiber distribution equipment that enables easy access for a technician to make or change connections. Despite an extremely high density of connections, the optical fiber distribution equipment may enable a technician to slide a tray forward and/or rearward for access to the front or back of the tray. Alternatively or additionally, a technician may slide a module forward relative to other modules in a tray for easy access to receptacles on the front of the module. Alternatively or additionally, the optical fiber distribution equipment may be configured to hold modules in one or more pre-defined positions. Some or all of these capabilities may be achieved with one of the following features or a combination of the following features.

In some examples, the optical fiber distribution equipment may include a chassis with a cover configured for mounting to a rack with hardware that extends in the front to back direction, reducing the space within the rack unit footprint for mounting hardware. That mounting hardware may be inserted into side rails of the rack outside the rack unit footprint. As a result, in comparison to conventional designs, less space within the rack unit footprint is required for mounting hardware, increasing space available within the rack unit footprint for optical fiber connections.

Alternatively or additionally, in some examples, a tray may be mounted on a roller attached to the chassis cover, enabling the tray to slide forward and/or backwards in the chassis. A detent, holding the tray in a desired position relative to the chassis, may be configured for mounting to the side rails of the rack, also outside the rack unit footprint, and also increasing space available within the rack unit footprint for optical fiber connections.

Alternatively or additionally, in some examples, modules may slide relative to a tray on rails. The rails may be attached to the tray such that a slot in a floor of each module may receive the rail to enable sliding engagement of the module to the tray. The rails may extend in a direction from the rear of the module forward for only a portion of the length of the module. Accordingly, even when the module is inserted in the tray to its maximum insertion depth, the slot in the module need not extend to the front of the module, such that space at the front of the module that can otherwise be occupied with LC receptacles is not required for slidably mounting the modules in the trays. As a specific example, the rails for each of multiple rows of modules in a tray may extend from a post extending perpendicularly from a floor of the tray. The post may be mounted toward the rear of the tray.

Alternatively or additionally, in some examples, the rails may be at central portions of the modules and a single rail may be provided per module. Accordingly, within a module, only a single slot may be provided, providing space for an optical fiber jumper to connect LC adapters at the front of each module to an MPO adapter at the rear.

Optionally, one or more features may be included to position modules relative to the tray. In some examples, the rail on which the module slides and a portion of the module bordering a slot in the module receiving the rail may each have one or more components that magnetically attract to the component of the other. One such magnetic component may be magnetized and the other may be a ferrite, such that the two components attract. One or more of the module and the rail may have one or more magnets attached to it. Magnets of the rail and the module, for example, may have opposite polarities such that the module is drawn into a position in which a magnet on the module is aligned with a magnet on the rail. The magnetically attracted components may be mounted such that they align when the module is in one or more desired positions relative to the tray. For example, the rail may have a first magnet positioned to align with a magnet on the module when the module is fully inserted in the tray. The rail may have a second magnet positioned to align with the magnet on the module when the module is pulled forward relative to other modules in the tray. These magnets may be positioned, for example, to hold the tray in a service position where a technician may plug and unplug LC connectors in the adapters at the front of the module, despite multiple modules with a high density of adapters being tightly packed within the tray.

As another example of a feature to position modules relative to the tray, modules may have a tail, extending in a rearward direction at the rear of the module. The module may engage a feature fixed to the tray once the module is pulled forward relative to the tray by a certain distance. For example, each module may have a tail with a hook at a distal end that engages a feature of the tray when the module is slid forward in the tray by a predetermined distance. That predetermined position, for example, may be a distance that places the module in the service position or slides the module beyond the service position but without disengaging the module from its rail, in other examples. In some examples, the tail may be flexible such that user may deflect the tail such that, as a module is pulled forward in a tray, the hook does not engage the tray. In this way, the technician may slide a module out of the tray if desired. A tail extending beyond the rear of a module may increase connection density because it does not require structures that would increase the width of a module in a direction parallel to the row of adapters, which could have the undesired effect of reducing the number of modules that fit in a row or the number of adapters at the front of the modules.

Optionally, a cable management component may extend from the module in a forward direction. For example, the cable management component may extend from the front of the module. The cable management component may be aligned with the slot that receives the rail on which the module is mounted. Alternatively or additionally, the cable management component may extend from the front of the module between two groups of adapters. The space between the groups of adapters may be narrow such that the cable management component extends in a thin blade from that space. The cable management component may enlarge towards its distal end to provide structures that receive optical fiber cables, such as those being routed to make connections through adapters on the front of the modules. In some implementations, the enlarged distal end of the cable management component may interfere with a technician accessing the adapters at the front of the module. The thin blade of the cable management portion may be oriented such that its thin dimension is parallel to the row of adapters in a module. The thin blade may be made sufficiently flexible that the distal end of the cable management component may be deflected in either direction parallel to the row. Accordingly, the thin blade may act as a flexure for the cable management component. With this configuration, a technician may alternatively flex the distal end of the cable management component to the left or right to provide better access to adapters to the right or left, respectively, of the cable management component. The cable management component may flex sufficiently, without yielding, to move the head end of the cable management component to the left or right by at least half its maximum width. With such flexing, a technician may move the head end sufficiently far to remove what would otherwise be interference from the head end with access to one or more of the adapters. The flexure may provide a range of movement that is at least half the maximum width of the head end, for example.

In some examples, the cable management components may be shaped as handles, enabling a technician to pull on a single module to move it forward relative to the tray. Alternatively, if cable management is not desired, a module may have a handle at the end of a flexible blade without providing a cable management structure.

Optionally, additional cable management components may be attached to outer sides of the tray. These additional cable management components may extend beyond the sides of the tray and may be aligned with side rails of the rack of the distribution frame so as not to occupy space within the rack unit footprint. These cable management components may also be shaped as handles and may be grasped, for example, by a technician to move the tray relative to the side rails. Alternatively or additionally, handles for moving the tray may be mounted in this location at the sides of the tray.

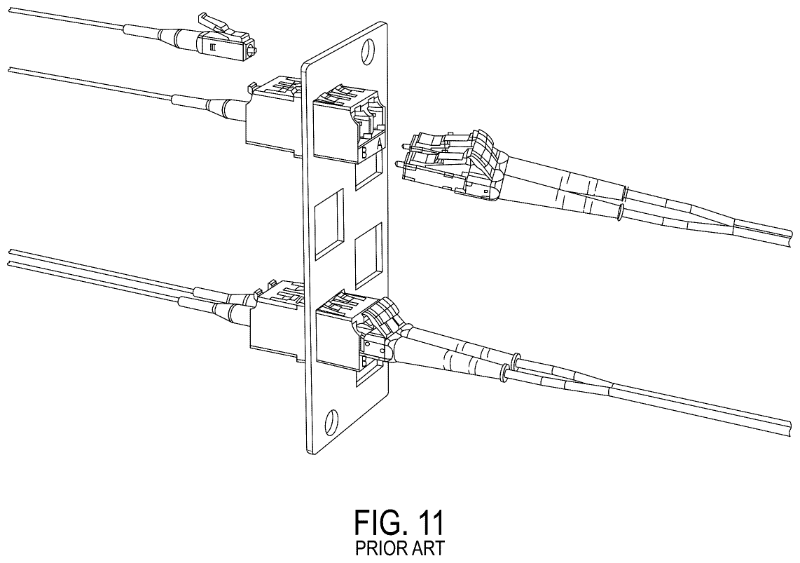

In any of the configurations described above, a module may have groups of multiple adapters across the front of the module. Each group of adapters may be integrally formed, with adapters for LC connectors spaced according to the standard for duplex spacing. Those LC connectors may be known in the art with a latch on a surface, which a user may release by depressing the latch with their fingers (see FIG. 11). Designs as provided herein, despite the tight spacing between adapters, may allow a user to manipulate conventional LC connectors for insertion and removal. The conventional LC connectors need not include modifications to enable a user to insert and remove the connectors without grasping the connector with their fingers, such as occurs when releasing the latch. Moreover, as illustrated in the drawings, extremely high connection densities may be achieved with only three rows of optical fiber connections in a 1U space, which can be achieved with standard LC connectors. Designs as disclosed herein do not need connectors modified to be shorter than standard LC connectors such that four or more rows of optical fiber connections fit in a 1U space.

As a specific example, a chassis configured for a 19-inch rack unit may have a tray with rails configured to receive three rows, each with 7 modules. Each of the modules may have across its front two groups of four LC adapters each, resulting in 168 LC adapters in a 1U footprint. In such a configuration, each module may have mounting locations for one or more MPO adapters at the rear. In some configurations, each module may have one MPO adapter at the rear.

The figures illustrate an exemplary chassis providing extremely high density fiber distribution. In the example, the chassis is described as a portion of a fiber distribution frame. One of skill in the art will understand, however, that such a chassis may fit within an equipment rack or cabinet. In the examples described herein, the chassis has a standard size, which facilitates use within any of multiple types of networking equipment.

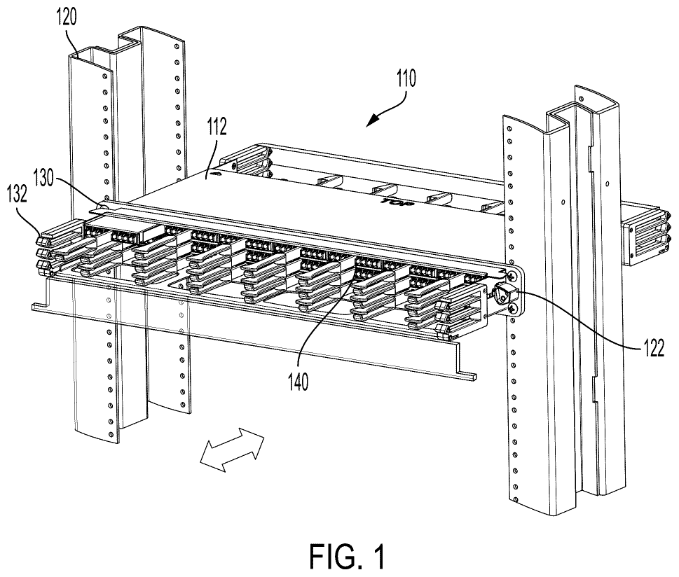

FIG. 1 illustrates a portion of the fiber distribution frame. Here segments of two side rails 120 forming a portion of a rack of the fiber distribution frame are shown. The segment of the side rails 120 illustrated may hold multiple chassis. In this example one chassis 110 is shown installed in the rack.

Chassis 110 is here shown with a cover 112 and a tray 130 that may slide relative to cover 112. The arrow illustrates a direction of sliding of the tray, in either a forward or a rearward direction. Cover 112 is attached at each side to side rails 120. A detent 122 is mounted to each of the side rails 120. Detent 122 is configured to engage with one of multiple features on tray 130, locking the tray in one of a number of predetermined positions. In the example illustrated, detent 122 is spring biased to rotate into engagement with a feature of tray 130, but may be rotated out of engagement to allow the tray to slide relative to cover 112 which is affixed to side rails 120.

Multiple modules 140 are carried by tray 130. In this example three rows of seven modules each are shown. The modules 140 have optical fiber connection elements at the front and rear. In this example, the optical fiber connection elements are receptacles that receive connectors and are specifically adapters. At the front, visible in FIG. 1, each of the modules in this example has LC connections. Each of the modules includes two groups of LC receptacles, here configured as adapters. In this example, each of the groups of receptacles has four receptacles, such that the front of each module provides eight LC connections.

In operation, fibers terminated with LC connectors may be routed across the front of chassis 110 and inserted into a receptacle at the front of one of the modules 140. Those cables may be supported by cable management components, such as side cable management components 132, which are attached to tray 130.

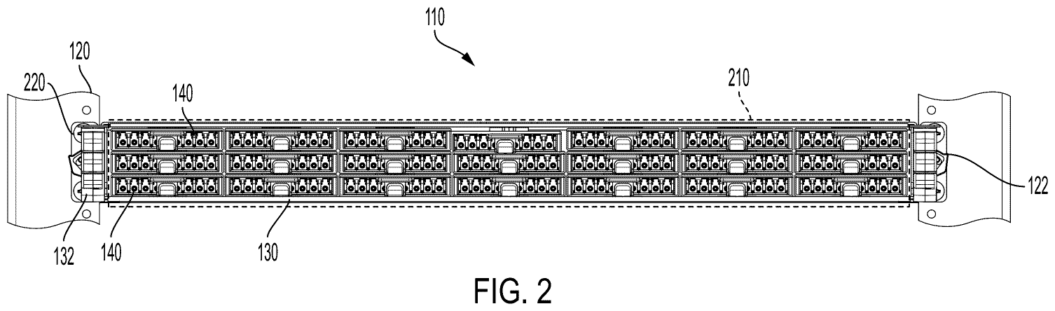

FIG. 2 is a front view of the chassis 110. From this perspective, it can be seen the chassis 110 fits within a one rack unit footprint 210. In this example a 19-inch rack unit is illustrated, as a density of LC connections per rack unit that can be achieved with a 19-inch rack unit may also be achieved with a 23-inch rack unit. As can be seen, rack unit footprint 210 is in the space between side rails 120. Twenty-one modules 140 fit within the one rack unit footprint 210, providing 168 LC connections in the one rack unit footprint 210. Each module, for example, may have a width between 2.65 and 3.17 inches, and may be about 2.7 inches wide, for example.

In the example of FIG. 2, multiple elements of the fiber distribution frame are aligned, in a front to back direction, with side rails 120 and are outside the rack unit footprint 210. Such positioning enables substantially all the rack unit footprint 210 to be used for modules and the LC receptacles they contain. As a specific example, mounting hardware 220, which holds cover 112 to side rails 120, extends in a front to back direction into side rails 120. Similarly, detents 122 are mounted outside of rack unit footprint 210. Side cable management components 132 are mounted on outer sides of tray 130 and are thus outside the rack unit footprint 210.

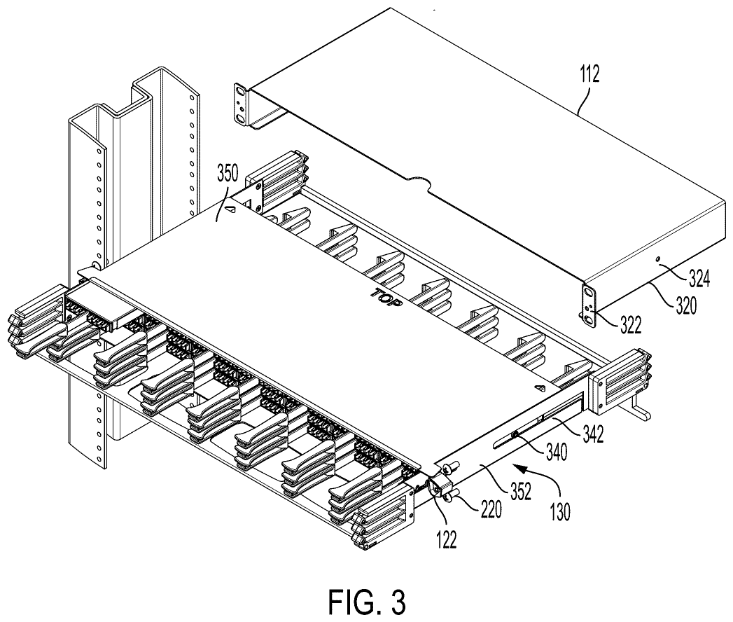

FIG. 3 shows chassis 110 with cover 112 removed. Right side rail 120 is not shown to reveal structure on the right side 352 of tray 130. In this figure, the front to back orientation of mounting hardware 220 can be seen. Mounting hardware 220, for example, may be screws, bolts or pins.

Cover 112 may be formed from sheet metal. As a result, side 320 may be thin yet strong enough to support tray 130. Mounting flange 322 may be integrally formed with side 320. Side 320 may also support hardware for slidably mounting tray 130 relative to the rack of the fiber distribution frame. In this example, that mounting is provided by a roller 340 that may be mounted on a bearing extending through opening 324 in side 320. Roller 340 may extend in a channel 342 cut in a front to rear direction in a side of tray 130, enabling tray 132 to roll on roller 340 as it moves in a forward or rearward direction.

Though not visible in FIG. 3, detent 122 may be rotatably mounted about a shaft attached to side rail 120. Detent 122 may have a projection that engages an opening in a side of tray 130. A spring may bias detent 122 such that the projection rotates towards tray 130 such that, when detent 122 is released, it rotates into position to engage tray 130. To enable tray 130 to slide, detent 122 may be rotated such that the projection moves away from tray 130. As with mounting hardware 220 for mounting chassis 110, the shaft or other mounting components for detent 122 may be elongated in a front to back direction so as not to extend into rack unit footprint 210.

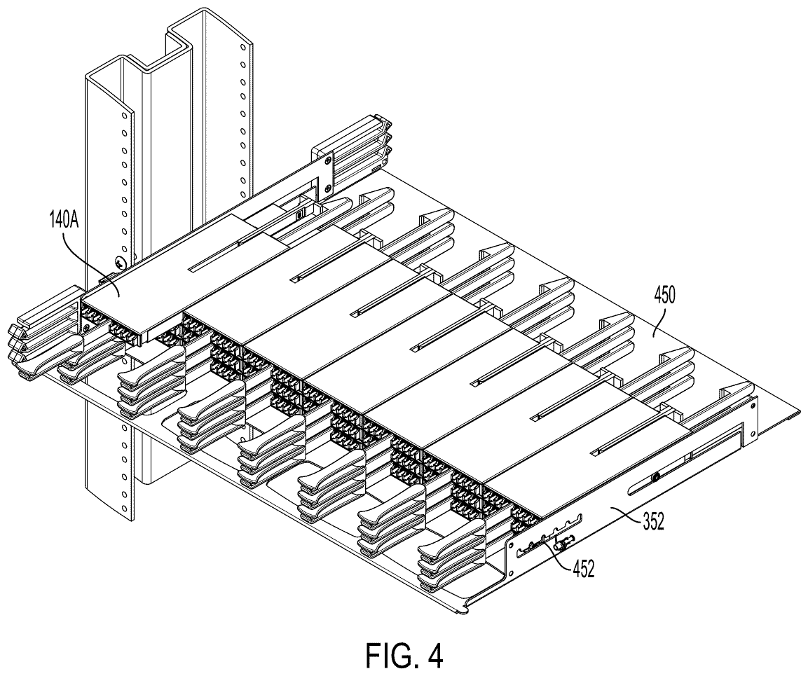

FIG. 4 shows the chassis of FIG. 3 with the cover (350, FIG. 3) of tray 130 removed. In this view, modules 140 inside the chassis are visible, as is the bottom 450 of tray 130. Both the cover and the bottom of tray 130 may be formed of sheet metal or similar material. Features, such as holes, to engage detent 122 may be formed in side 352. In this example, those features are provided by a second channel 452 in side 352. Second channel 452 has multiple notches cut along its length. Each such notch may receive a projection from detent 122 when the tray is slid into a position in which the notch aligns with that the notch, thereby providing multiple locations in which the tray may be secured.

In the example of FIG. 4 all the modules 140 within chassis 110 have the same configuration. Module 140A is shown slid forward into a service position. In this service position, for example, a technician may access one or more of the optical fiber connections at the front of module 140A. A technician, for example, may access a module to insert or remove a connector into a receptacle on the front of the module. Alternatively or additionally, a technician may access the front of the module to clean mating faces of optical fibers inside the module positioned for mating to a connector or plugged into the front of the module.

As can be seen in the drawings, including FIG. 4, a single tray supports multiple rows of modules. Accordingly, at least some of the rows may be regarded as tray-less in the sense that the modules in the row are not supported in a separate tray. Rows of tray-less modules that nonetheless can be accessed, such as by sliding an entire group of modules forwards or backwards or sliding an individual module forward or backwards, may provide conventional access to the modules with more room for optical fiber connections in the same space.

In the illustrated example, the modules 140 are configured to slide on rails from a fully inserted position to a service position and/or may be slid far enough in the forward direction to be removed from the front of chassis 110. The rails may be elongated in a direction from a rearward portion of the tray towards the front and may have a width in the top to bottom direction that approximates the width of a module. Each rail may be thin in a direction perpendicular to the direction of the rows of adapters in the module.

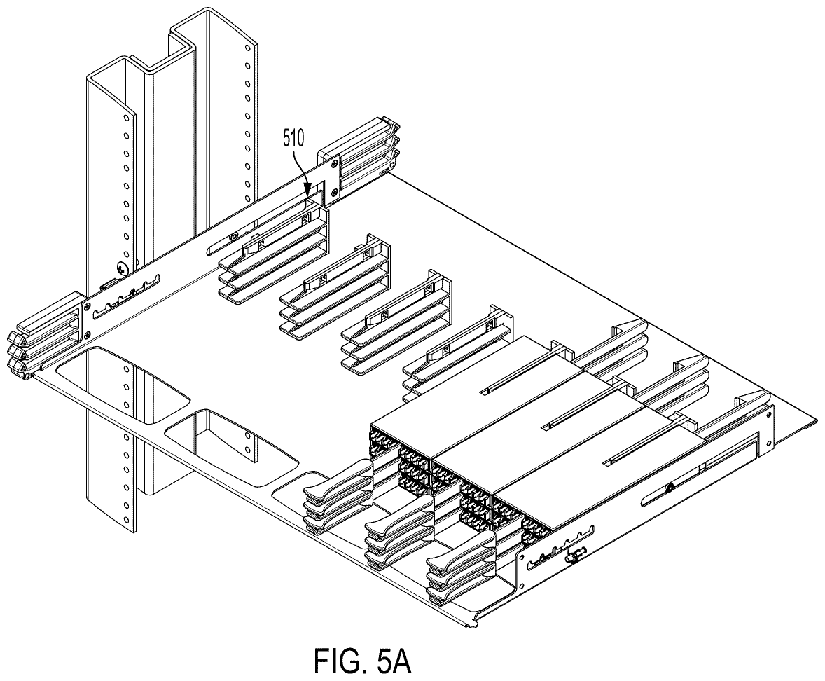

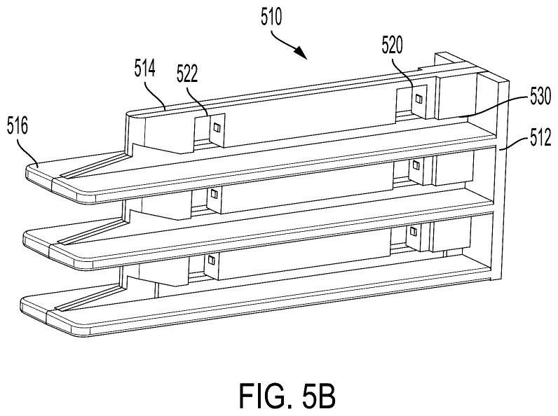

Rails to facilitate sliding of one or more modules may be implemented as a rail subassembly. FIG. 5A shows chassis 110 with four columns of modules removed, revealing rail subassemblies 510 that support and enable sliding of those modules. In the illustrated example, a rail subassembly is provided for each of the seven columns of modules in the chassis.

FIG. 5B is a perspective view of a rail subassembly 510. Each of the rail subassemblies may be mounted to bottom 450 of tray 130. Mounting, for example, may be through screws or other fasteners, adhesives, or through engagement of features on bottom 450 and on a lower surface of rail subassembly 510.

Each rail subassembly 510 may have a rail 514 for each of the modules supported by the rail subassembly. In the example in which modules are stacked three high on a tray, rail subassembly 510 includes three rails 514. The rails 514 extend from a rear portion of rail subassembly 510, here shown as post 512. Post 512 here serves as a rear wall of rail subassembly 510 and may restrict insertion of a module sliding on a rail 514 beyond a predetermined distance into a tray 130. Additionally, rail subassembly 510 may include a platform 516 extending perpendicular to rail 514. A platform 516 may be below each rail 514 to support the module sliding along the rail 514.

Rail subassembly 510 may be formed as one or more components. In the example of FIG. 5B, the entire rail assembly is formed as a monolithic element, such as by molding plastic into the shape pictured. Such a construction may provide structural integrity to each of the rails 514, despite being thin.

Rail subassembly 510 may include components for positioning the modules that slide along the rail. In the example of FIG. 5B, rail subassembly 510 includes openings 520 and 522 to receive magnets. In this example, magnets of the same polarity may be inserted into each of openings 520 and 522. A magnet in openings 520 may align with a magnet in module 140 of an opposite polarity when the module is fully inserted into the tray. A magnet in an opening 520 may align with the same magnet in a module 140 when the module is pulled forward into the surface position. By having magnets of opposite polarity in the rail and in the modules, the positioning of the magnets in the rails and the modules may define one or more locations in which a module may be held within the tray, such as when fully inserted for use or when pulled out into a service position. In this example, these features that position the modules in a forward or rearward direction along rails 514 are embedded in the rails and do not occupy and additional space within the rack unit footprint.

In the illustrated example, each module has a housing, which may be constructed in one or more pieces. The module housing, for example, may be molded of plastic. Such a housing may be molded in two pieces, such as a top cover 610 and a bottom 612.

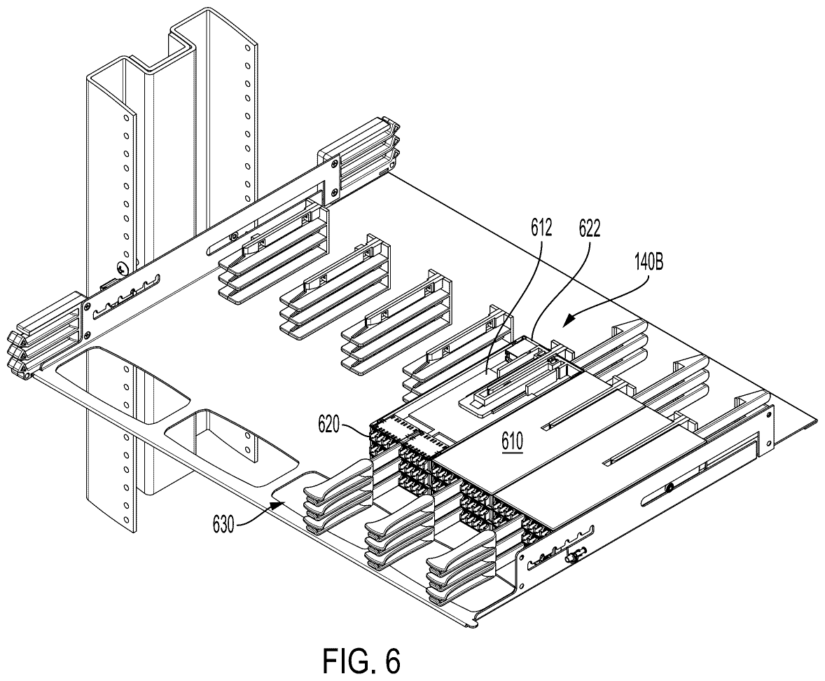

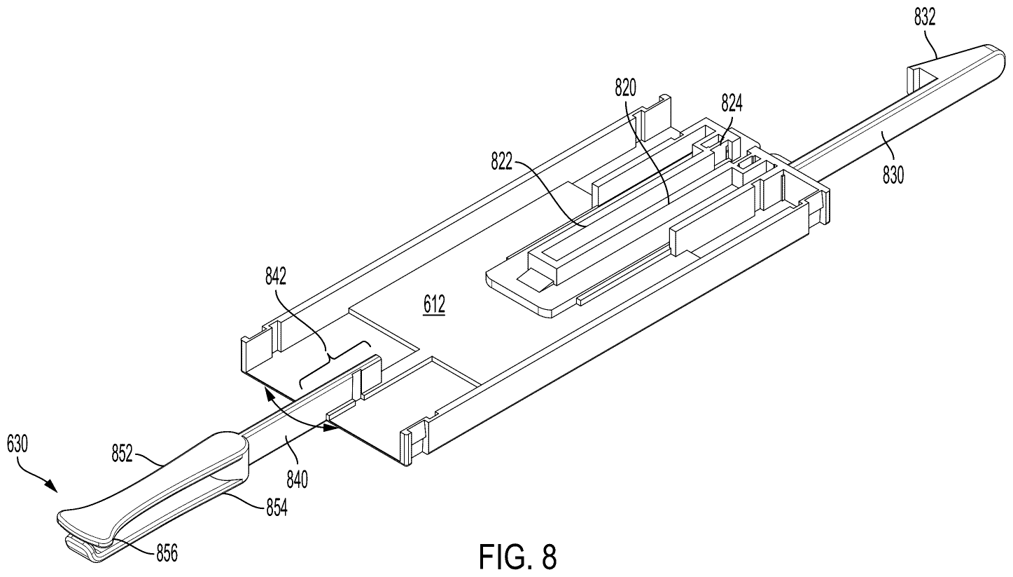

FIG. 6 shows a module 140B with a top cover 610 removed, exposing the module bottom 612. In this example, module bottom 612 includes a slot (820, FIG. 8) through which a rail 514 extends. When inserted into a tray, module bottom 612 may rest on a platform 516 of rail subassembly 510. Module top 610 may have a slot aligned with the slot in the module bottom 612, and rail 514 may extend above platform 516 for a distance approximately equal to the height of the module.

With module top 610 removed, groups of LC adapters 620 are visible at the front of module 140B. MPO adapter 622 is visible at the rear of module 140B. In the use, a jumper may connect LC connectors inserted into LC adapters 622 from the rear and an MPO connector inserted into MPO adapter 622 at the rear of the module. For simplicity, a jumper is not illustrated, but it can be seen that because slot 820 extends from the rear of the module only a portion of the length of the module in the rear to front direction, there is room within the module between the end of the slot and the adapters 620 for the jumper to be routed to adapter 622 at the rear.

In the illustrated example, each of the groups of adapters 620 has four adapters. The adapters are configured to received LC adapters and are spaced, center-to-center according to the spacing specified for a duplex LC adapter. Each group is integrally formed. The groups in this example are separated by a cable management component 630.

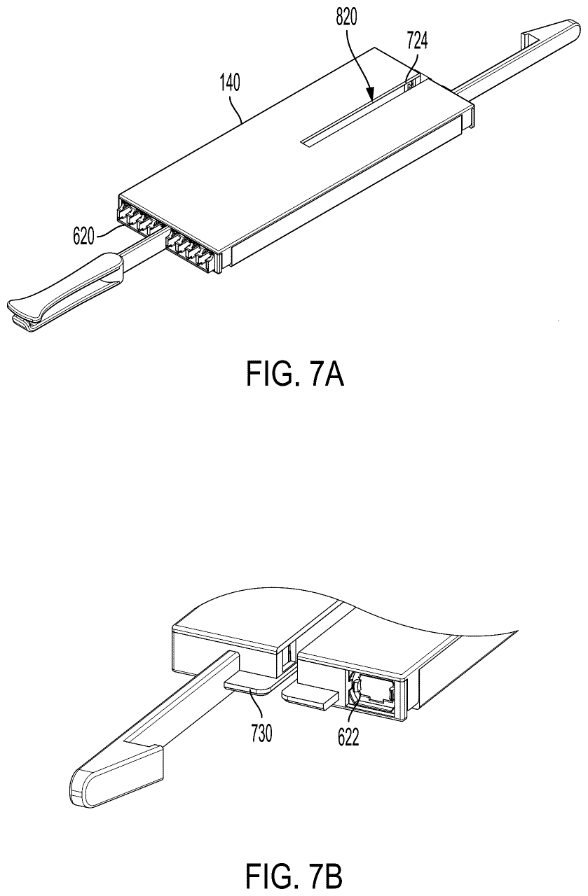

FIG. 7A shows a module 140 removed from the chassis 110. In this view, slot 820 is visible. Magnet 724 can be seen bounding slot 820. Magnet 724 may be of the opposite polarity of the magnets inserted into each of openings 520 and 522. Attraction between magnet 724 and a magnet in either opening 520 or 522 will hold the module 140 in one of two positions. In magnet 724 is aligned with the magnet in opening 520, module 140 may be held in its fully inserted position. When module 140 is pulled out such that magnet 724 aligns with a magnet in opening 522, module 140A may be held in a service position.

FIG. 7B shows a rear portion of module 140. Module 140 may include one or more features that interact with other components for retaining or stabilizing module 140 within the tray. In this view, tabs 730 extending from the rear face of module 140 are visible. Tabs 730 may fit under shelves 530 (FIG. 5) when module 140 is fully inserted into the tray. Engagement between tabs 130 and shelves 530 may stabilize module 140 in the tray.

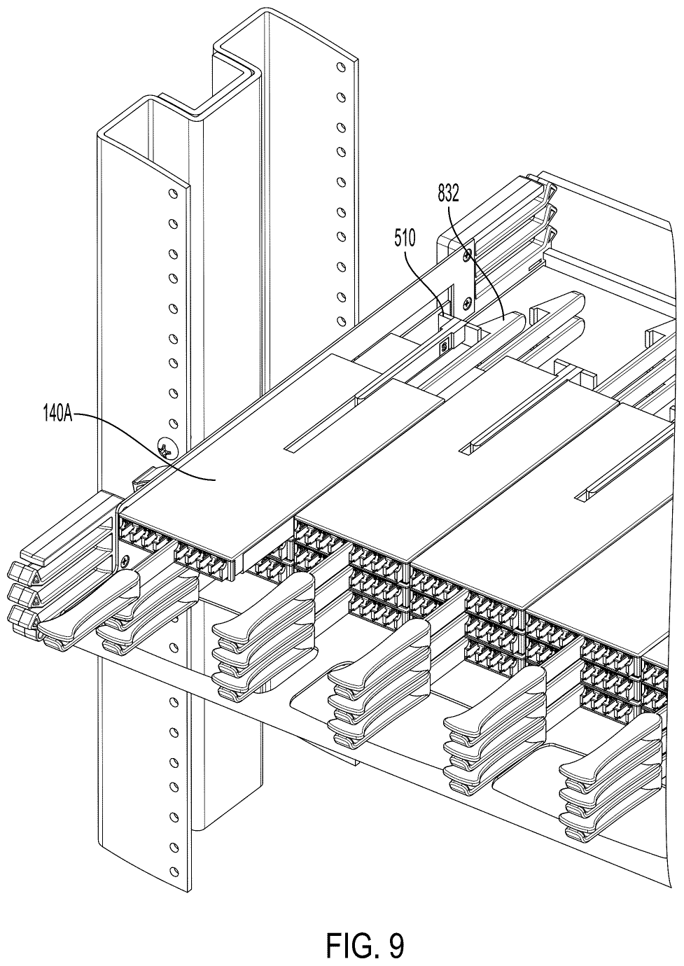

FIG. 8 shows a tail 830 extending from the rear face of module 140. As illustrated in FIG. 9, when a module, such as module 140A is pulled forward in the tray, a hook 832 at a distal end of the tail 830 may engage rail subassembly 510, precluding module 140A from being further with drawn from the tray. To fully withdraw module 140A from the tray, a technician may deflect tail 830, such that hook 832 clears post 512 at the rear of rail assembly 510. To enable this flexing motion, tail 830 is relatively thin in the direction in which it is flexed to clear post 512.

Returning to FIG. 8, further details of module 140 are shown. Walls 822 bounding slot 820 are visible in this figure. Openings 824 are formed in walls 822 for receiving magnets 724.

Further details of cable management component 630 are also visible in this figure. Cable management component 600 is configured to flex from side to side in the direction of the arrow illustrated. Such flexing motion may enable a technician to service all of the connection elements in the face of the module, even though some may be partially blocked by cable management component 630.

As shown in FIG. 6, a root portion 842 of cable management component 630 is attached to bottom 612 of module 140. This root portion 842 provide mechanical support for cable management portion 630. Root portion 842 is within the row of LC adapters held in the module. Thus, while root portion 842 occupies space within the rack unit footprint when the module is installed in the tray, it occupies only a small space, less (e.g. less than 25% or less than 20% or less than 10%, or less than 5% in some examples) than the width of the head end of the cable management portion 630, which provides the functions or supporting cables and/or providing a handle to enable easy movement of modules.

A flexure 840 extends from root portion 842. Flexure 840 is also thin. In this example, flexure 840 is the same width as root portion 842. Flexure 840 joins head end 856 of cable management component 632 to root portion 842. Head end 856 is shaped to hold cables, which may be routed to make connections to an adapter at the front face of any of the modules in the same row in the chassis as the illustrated module. To hold cables, head end 856 has an upper arm 852 and a lower card 854. These arms may flex such that a cable may be inserted between them.

In the example illustrated, cable management component 630 also serves as a handle for a technician to grasp when pulling a module forward from the tray or pushing the module rearward into the tray. To provide robust support for cables as well as to provide an ergonomic gripping surface for a technician using the cable management component as a handle, head end 856 is substantially wider than root portion 842. As a result, head end 856 may block access to adapters in the front face of module 140, particularly the adapters that are immediately adjacent to root portion 842, which may be positioned as close to root portion 842 as possible to provide a high density of connections across the front face of the module.

Nonetheless, the design as illustrated in FIG. 8 may enable a technician to access all the adapters for service, such as inserting a connector, removing a connector, or cleaning a connector on a jumper that is inserted in the adapter from inside of module. Flexure 840 may serve as a hinge that enables head end 856 to be moved to one side or the other such that adapters on each side of root portion 842 may be alternatively exposed. Here, the thin elongated shape allows flexing motion as illustrated by the arrow in FIG. 8. As illustrated by the arrow in FIG. 8, flexure 840 enables the cable management component to be moved away from a group of adapters on one side of the flexure to access that group of adapters and to move the flexure away from that group of adapters to access another group of adjacent adapters.

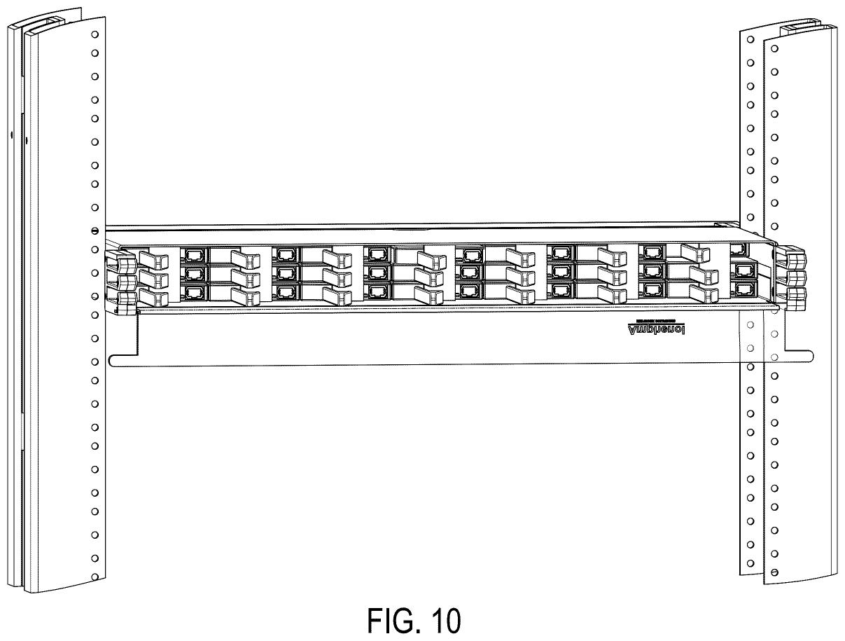

FIG. 10 shows chassis 110 mounted in a rack from the rear.

### Examples

In one example, a module for a fiber distribution chassis may have a connection density of 168 LC connections per rack unit.

In another example, a module for a high density fiber distribution chassis may have a housing comprising a front face, a first plurality and a second plurality of optical fiber connection elements exposed in the front face, an element, and a distal portion having a maximum width wider than the flexure. The element may have a first portion affixed to the housing between the first plurality of optical fiber connection elements and the second plurality of optical fiber connection elements and a flexure coupled to the first portion. The flexure may be configured to flex in a direction to move the distal portion alternatively towards the first plurality of optical fiber connection elements or the second plurality of optical fiber connection elements.

Optionally, a module according to any of the foregoing examples may have one or more of the following features:

A slot configured to receive a rail that extends partially in the front to back direction.

IA plastic housing comprising one or more walls and one or more magnetic elements affixed to the one or more walls.

Two groups of four fiber optic adapters exposed at a front face, each of the groups being integrally formed.

In another example, a high density fiber distribution chassis may have a cover comprising a side and a mounting flange extending from the side, a tray mounted within the cover to slide in a front to back direction, and a detent rotatably coupled to the chassis at a location aligned within the flange in a front to back direction, configured to engage the tray when rotated into a first position and disengage from the tray when rotated into a second position.

In a further example, a high density fiber distribution chassis may have a cover comprising opposing sides separated by a distance defining a footprint one rack unit wide therebetween and positioning means for positioning modules within the rack unit footprint, with a density of 148 to 168 LC connections per rack unit.

Optionally, a chassis according to any of the foregoing examples may have one or more of the following features:

Three rows of modules, each row having seven modules.

A cover comprising a side, a tray mounted within the cover, and a roller engaged to the cover and the tray such that the tray is slidably mounted within the cover.

Various aspects of the apparatus and techniques described herein may be used alone, in combination, or in a variety of arrangements not specifically discussed in the embodiments described in the foregoing description and is therefore not limited in its application to the details and arrangement of components set forth in the foregoing description or illustrated in the drawings. For example, aspects described in one embodiment may be combined in any manner with aspects described in other embodiments.

As another example, LC connections at the front of each module were described based on receptacles configured to receive LC connectors, which were illustrated as LC adapters. Optionally, LC connections may be made in other ways. For example, LC connections may be made with elements that have a mating interface of an LC plug. Such elements may be in groups of elements spaced by the spacing of LC connectors in a duplex plug. Alternatively or additionally, connection components may be mixed in a module, with some plug element and some receptacle elements, for example.

Further, it is not a requirement that connections be made with an LC form factor. Techniques as described herein may be used in modules configured for other types of connections instead of or in addition to LC connections.

Other configurations are contemplated. A module may have two or more MPO adapters at the rear, for example, or a mix of single fiber connectors and MPO connectors at either the front and/or rear.

Also, a 1 rack unit chassis was used as an exemplary embodiment. A 2U chassis may be constructed with 6 rows of modules, which may be organized in a single tray or distributed on multiple trays. A 4U chassis may be constructed with 12 rows of modules, etc.

As another example, a flexure is shown integrally molded with a module housing. A flexure may alternatively be formed as a metal strip, for example.

Further, structures on a right side of a chassis were pictured and described. Analogous structures on the left side are not pictured or described in detail for simplicity, but structures such as mounting components and a detent or other structures asked described or pictured herein, may optionally be symmetrically disposed on both the left and right sides of the chassis.

Further, modules in a chassis configured to be mounted on rails separated by a standardized distance were pictured and described. Network equipment racks, cabinets and frames may have such rails and the chassis as described herein may be used in any such equipment. Accordingly, the term “chassis” does not imply a limitation on the use or operating environment of the equipment described herein. A chassis, for example, may be any support structure.

Further, it should be appreciated that all features described above need not be included in a single embodiment. For example, a tray that can slide relative to the chassis was pictured. However, a tray may serve as portion of the support structure of a chassis without being slidably mounted within the chassis, such that in some embodiments a tray may be fixed relative to other components of the chassis.

Directional terms, such as front, back, top, bottom, right, and left have been used to described relative positions of components. These terms are used in relation to a conventional configuration of a distribution frame, as viewed from the front, in which side rails to which a chassis is attached, run perpendicular to a floor, with the front facing a cable routing channel and the rear facing a bank of network devices. However, it should be appreciated that these terms are used to signify relative orientation and do not require any specific orientation of the fiber distribution frame and/or any of its components in use.

Further, certain elements are described as being attached to or a part of the bottom or cover of the module. Some or all of the elements that are shown in connection with the cover alternatively may be attached to or part of the bottom, and vice versa.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “substantially,” “approximately,” “about” and the like refer to a parameter being within 10%, optionally less than 5% of its stated value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A module for a fiber distribution chassis having a connection density of 168 LC connections per rack unit.

2. The module of claim 1, comprising:
a plastic housing; and
one or more magnetic elements embedded within the plastic housing.

3. The module of claim 1, comprising:
two groups of four fiber optic adapters exposed at a front face, each of the groups being integrally formed.

4. The module of claim 3, wherein the module has a width between 2.65 and 3.17 inches.

5. The module of claim 1, having adapters for eight fiber optic connections exposed at a front face, wherein the fiber optic adapters comprise a plurality of integrally formed components, each comprising adapters for a plurality of fiber optic connections.

6. The module of claim 5, further comprising:
a housing comprising the front face; and
an element, comprising:
a flexure extending from the housing perpendicular to the front face; and
a distal portion, coupled to the flexure having a maximum width wider than the flexure, wherein the flexure is configured to flex to move the distal portion away from at least a subset of the adapters.

7. The module of claim 1, wherein the module is configured for use in a tray-less row of modules within the chassis.

8. A module for a high density fiber distribution chassis, the module comprising:
a housing comprising a front face;
a plurality of optical fiber connection elements exposed in the front face; and
an element, comprising:
a first portion affixed to the housing adjacent at least a subset of the optical fiber connection elements of the plurality of optical fiber connection elements;
a flexure coupled to the first portion; and
a distal portion, coupled to the flexure, having a maximum width wider than the flexure, wherein the flexure is configured to flex in a direction to move the distal portion alternatively towards the at least a subset of the plurality of optical fiber connection elements or away from the at least a subset of the plurality of optical fiber connection elements.

9. The module of claim 8, wherein the module is configured to be disposed within the high density fiber distribution chassis with a plurality of like modules in three rows to provide a connection density of greater than about 144 LC connections per rack unit.

10. The module of claim 9, wherein the module is configured for use in a tray-less row of modules within the high density fiber distribution chassis.

11. The module of claim 10, comprising:
a slot configured to receive a rail in the high density fiber distribution chassis.

12. The module of claim 8, wherein the housing is plastic and the element is integrally molded with the housing.

13. The module of claim 12, wherein the distal end of the element is configured to support a plurality of optical fiber cables.

14. The module of claim 13, wherein the distal end is configured as a handle for use in moving the module relative to the high density fiber distribution chassis.

15. The module of claim 8, wherein:
the housing comprises one or more walls; and
the module further comprises one or more magnetic elements affixed to the one or more walls.

16. A high density fiber distribution chassis having a front, comprising:
a plurality of modules, each module comprising fiber optic connection elements exposed at the front,
wherein:
the plurality of modules are disposed in a plurality of rows; and
at least one of the plurality of rows is trayless such that the plurality of modules provide within the chassis a density of fiber optic connections of at least 148 LC connections per rack unit.

17. The high density fiber distribution chassis of claim 16, wherein the density of fiber optic connections within the chassis is 168 or less.

18. The high density fiber distribution chassis of claim 16, wherein:
the chassis comprises a tray; and
three of the plurality of rows are supported by the tray, whereby at least two of the three rows are tray-less.

19. The high density fiber distribution chassis of claim 18, wherein:
the tray is slidably mounted in the chassis.

20. The high density fiber distribution chassis of claim 18, wherein:
at least some of the plurality of modules comprise an element comprising:
a flexure extending perpendicular to the front; and
a distal portion, coupled to the flexure, having a maximum width wider than the flexure, wherein the flexure is configured to flex to move the distal portion away from at least a subset of the fiber optic connection elements.
